(19) United States
(12) Patent Application Publication
(10) Pub. No.: US 2018/0024726 A1
(43) Pub. Date: Jan. 25, 2018

(54) Personified Emoji

(71) Applicant: Cives Consulting AS, Stavanger (NO)

(72) Inventor: Gunnar Hviding, Stavanger (NO)

(73) Assignee: Cives Consulting AS, Stavanger (NO)

(21) Appl. No.: 15/216,131

(22) Filed: Jul. 21, 2016

(51) Int. Cl. G06F 3/0484; G06T 7/00; G06T 11/60; G06K 9/00

(52) U.S. Cl. CPC G06F 3/04845; G06K 9/00281; G06K 9/00248; G06K 9/00308; G06T 7/0032; G06T 11/60; G06T 2207/30201

(57) ABSTRACT

Systems and methods of generating personified emoji include a digital image of a user. Facial features identified in the digital image are represented by facial data generated from the digital image. An emoji template is accessed and modified with the facial data to create a personified emoji which contains embedded information about the user's face, as represented in the digital image.

### BACKGROUND

The present disclosure relates to the field of electronic communication more specifically, the present disclosure relates to personified emoji for use in interpersonal electronic communication and methods of generating the same.

An emoji is a pictorial representation of a facial expression and is commonly used in electronic written communication to express a person's feeling or mood. In electronic written communication, for example, but not limited to email, text messaging, chat/instant messaging and social media use of emoji can provide meta communication or secondary information as to how the rest of the written communication should be interpreted. As social media and other written electronic communication has become widespread, so has the use of the emoji to convey additional tonal or emotional context to the communication.

Since emoji are often used in place of real facial expressions, body language or other contextual cues available in face-to-face interpersonal communication, greater correspondence between emoji use and the communicator's physical appearance may help to strengthen these communications. While a wide variety of standardized emoji's are available, enabling a user to select between a limited number of emoji avatars including animals, for example cats, and modify it to adjust skin color. However, this provides little personal context or relation to the use of such emoticons and is entirely dependent upon the manual selection of predefined emoji.

Therefore, it is desirable in the field of electronic communication for solutions which present more personalized emoji's which exhibit physically identifiable features representative of the sender both to enhance the correspondence between the emoji and the sender's actual expressions, to improve interpersonal communication as well as vanity or novelty purposes to use personified emojis. This should not be confused with printing a whole or partial actual image onto an emoji template. This invention aims to embed (data of) the personal features of a person into an emoji template.

### BRIEF DISCLOSURE

An exemplary embodiment of a method of generating a personified emoji includes obtaining a digital image of a user. A facial data set of facial data is generated. The facial data in the facial data set is representative of facial features identified in the digital image. An emoji template is modified with the facial data of the facial data set to create the personified emoji. Thus an emoji is created wherein the person facial data is embedded.

An exemplary embodiment of a system for personified emoji includes a first memory for storing an emoji template. A processor receives a digital image of a user. The processor generates a facial data set of facial data quantifying facial features in the digital image. The processor further modified the emoji template with the facial data of the facial dataset to produce a personified emoji. A second memory stores the personified emoji.

An exemplary embodiment of a system for personified emoji includes means for creating a personified emoji. The personified emoji includes plurality of modified facial feature templates. The plurality of modified facial feature templates are produced from facial feature templates which are modified with facial data representative of a facial feature in a digital image of a user. The modified facial feature templates are arranged on the personified emoji in accordance with the facial data.

### BRIEF DESCRIPTION OF THE DRAWINGS

In the following are described examples of preferred embodiments illustrated in the accompanying drawings.

FIG. 1 is a flow chart that depicts an exemplary embodiment of a method of creating a personified emoji.

FIG. 2A depicts an exemplary embodiment of a first digital image.

FIG. 2B depicts an exemplary embodiment of a graphical user interface presenting various examples of facial data.

FIG. 2C depicts examples of facial data.

FIG. 2D depicts an exemplary embodiment of an emoji incorporating transformed facial data.

FIG. 2E depicts an exemplary embodiment of a first personified emoji.

FIG. 3 is a flow chart that depicts a detailed exemplary embodiment of a method of creating a personified emoji.

FIGS. 4A and 4B depict a second exemplary embodiment of a second digital image and second personified emoji.

FIGS. 5A and 5B depict a third exemplary embodiment of a third digital image and third personified emoji.

FIGS. 6A-6C depict still further exemplary embodiments of digital images and personified emoji.

FIG. 7 depicts an additional exemplary embodiment of a personified emoji including manually manipulated features.

FIG. 8 is a flow chart that depicts a detailed exemplarily embodiment of obtaining facial data.

### DETAILED DISCLOSURE

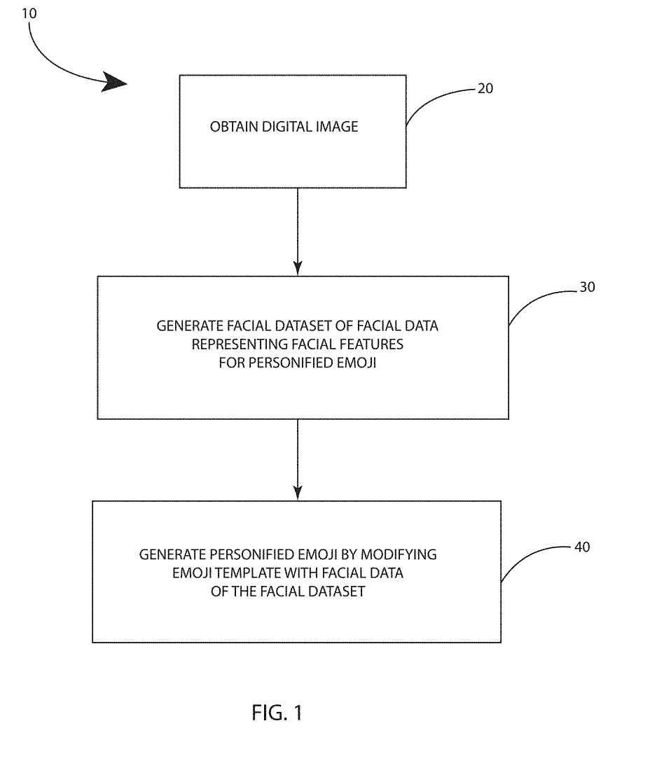

FIG. 1 is a flow chart that depicts an exemplary embodiment of a method 10 of creating a personified emoji. The method 10 begins with obtaining a digital image at 20. Exemplarily, the digital image is obtained as a digital photo taken by a camera. While not so limited, the camera may be one which is integrated with a mobile computing device, for example for a smart phone, tablet, or laptop or desktop computer. In embodiments, the digital image may be captured with a camera at the time of performing the method 10, while alternatively, the digital image may be stored in a computer accessible memory, having been captured at an earlier time. In still further embodiments, the digital image may be captured by scanning an analog photograph or captured from a frame of a video. Other manners of sources for digital images will be recognized a person of ordinary skill in view of these examples, and these examples are not intended to be limiting upon the sources of digital images.

The method 10 as described herein is exemplarily performed by a processor which is communicatively connected to computer readable memory embodying computer executable code, which upon execution by the processor causes the processor to perform the functionality and actions as described in further detail herein. Therefore, at 20, the digital image, regardless of the source from which the digital image was captured and/or stored, is obtained by the processor implementing the method 10.

At 30 a facial dataset of facial data is generated that represent facial features for a personified emoji. As will be described in further detail herein, the facial dataset of facial data is generated from analysis of the digital image obtained at 20. Facial recognition techniques may be used to identify facial features or other characteristics of the user face from the digital image. For example, facial recognition techniques may be used to identify distinctive features on the surface of the user's face in the digital image for example, the shape of the face itself, contour of the eye lids and sockets, nose, mouth and chin. Once facial features are identified, the facial features themselves as well as their relative positions can be measured or otherwise quantified. The facial data is embodied in these measurements and is compiled to produce the facial data set which exemplarily characterizes the shape, size, form, angle and relative positioning of various facial features in relative and/or in absolute terms to each other. The facial data represents the facial features to be included in the personified emoji.

A personified emoji is generated at 40 by modifying an emoji template with the facial data of the facial data set. In an exemplary embodiment, the method begins with a predetermined emoji template. In other embodiments, a user may select an emoji template to be personified. The method registers the facial dataset to the emoji template. Then, the method personifies the emoji template to produce the personified emoji by transforming the facial features represented in the emoji template according to the facial data of the facial data set. This produces a personified emoji in which the facial features of the personified emoji embody the shape, size, form and/or relative positioning of the same facial features of the user as represented in the digital image.

As humans are generally skilled at recognizing and identifying faces, as well as interpreting the expression conveyed by faces, greater correspondence between the facial features of the emoji used by a specific person to that person's own facial features can help the user to more effectively communicate in electronic interpersonal communication with a recipient of such communications. It is believed that the embedded facial data in the emoji will enable the sender and receiver to respectively convey and obtain additional information in a communication, both on a conscious and sub-conscious level.

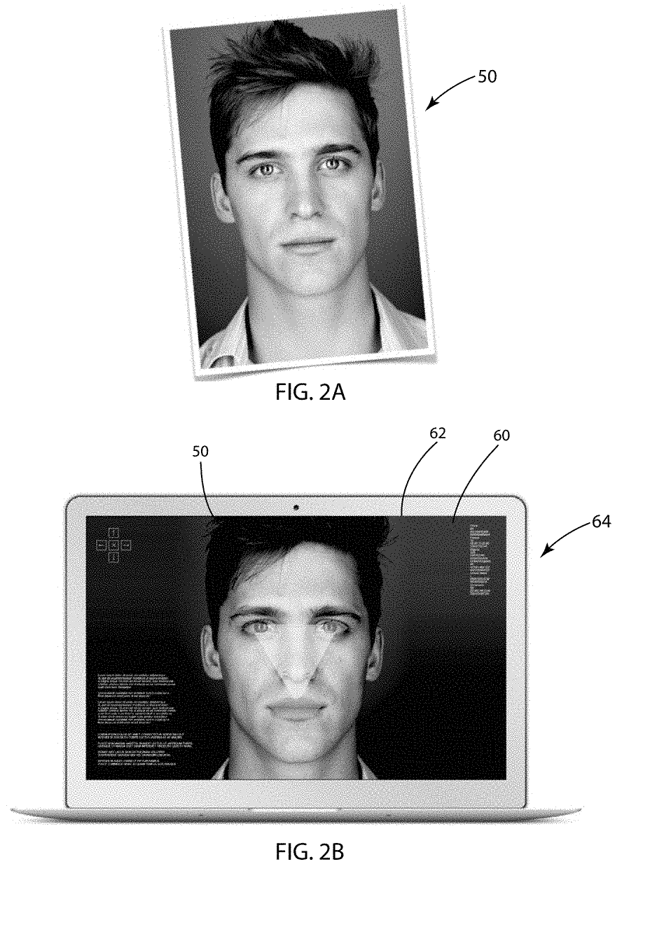

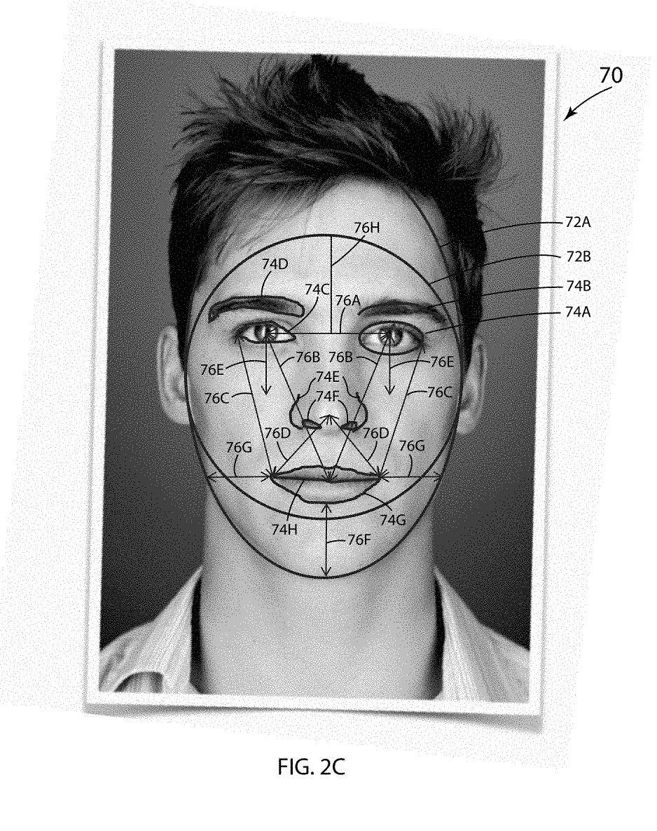

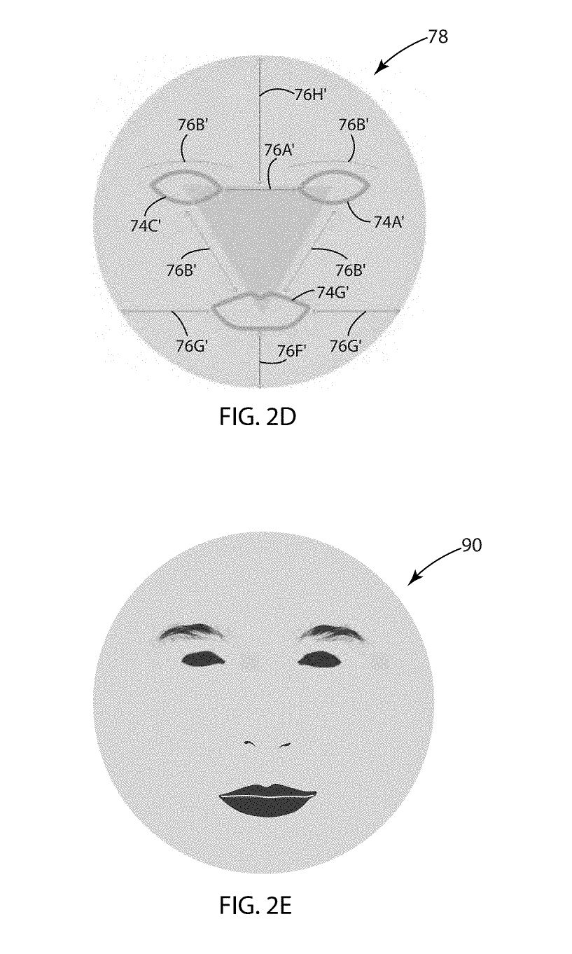

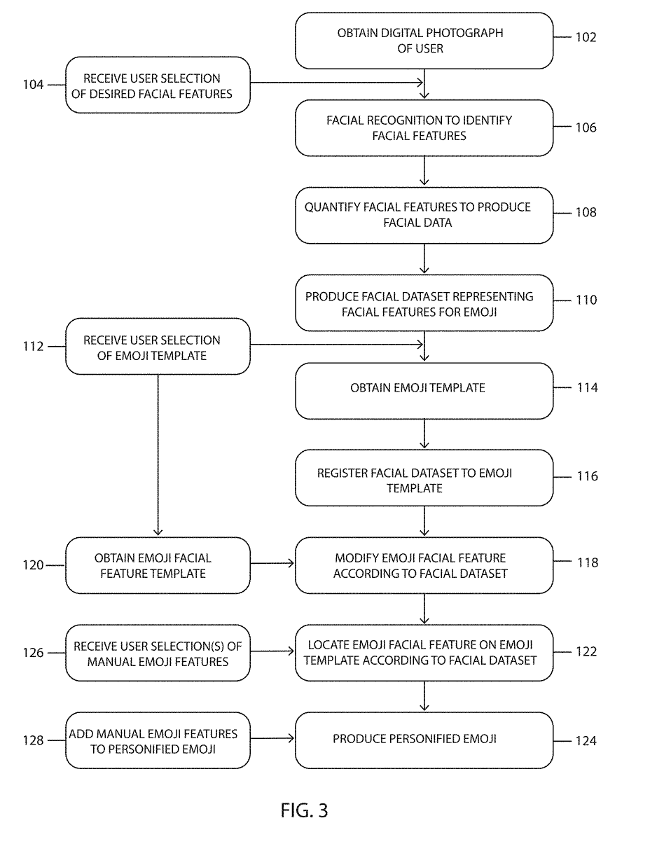

FIG. 3 is a flow chart that depicts an exemplary embodiment of a method 100 of creating a personified emoji. The method 100 exemplarily expands upon the method 10 as described above with respect to FIG. 1. The method 100 will further be explained by reference to FIGS. 2A-2E which provide non-limiting examples to visualize aspects of the methods, as disclosed herein. As noted above, exemplary embodiments of the method 100 may be implemented by a computer processor and/or computer processors, which may be located on a computing device for example a mobile computing device, while in other embodiments may be carried out by a processor connected to a remotely located server upon which some or all of the electronic data, algorithms, and/or executable files as used to implement such embodiment may be located.

At 102 a digital image of the user is obtained. An exemplary embodiment of a digital image 50 is depicted in FIG. 2A. As described above, this digital image may either be captured at the time of carrying out the method or may be a previously captured photograph which had been stored in computer readable memory.

In optional embodiments as described in detail herein, at 104 the method 100 may receive a user selection or selection of desired facial features to be included in the personified emoji. For example, a user may select that the physiological features of eyes, nose, lips, and eyebrows should be used in producing the personified emoji. While another user may select to include or exclude ears, chin, facial hair or to include or exclude a nose or eyebrows. It will be recognized that user selection of desired facial features at 104 may be optional and that in other embodiments a predetermined or default set of facial features may be used. In one example, this may include the eyes and mouth, or may be exemplarily expanded to include lips, nose, and eyebrows.

At 106 facial recognition techniques are used to identify facial features. In an embodiment wherein a user selection has been received, or a default selection of desired facial features has been received, this may be used to limit the identified facial features. In another embodiment, the facial recognition techniques may be used to identify all identifiable facial features within the ability of such a technique. Nonlimiting examples of facial recognition algorithms which may be used in exemplary embodiments include, but are not limited to principal component analysis which may include Eigen faces, linear discriminate analysis, elastic bunch graph matching which may further use the Fisher face algorithm, a hidden Markov model, multilinear subspace learning which may use tensor representation, and neuronal motivated dynamic link matching. Such facial recognition techniques may be augmented (or replaced) by the use of Pixel analysis or other contour tracing and classification techniques to enhance the accuracy of the facial data, particular in identifying contour lines around eyes and mouth as well as personal characteristics as scars or moles. In still further examples, three dimensional face recognition techniques may also be used to capture information about the shape of a face and its dimensions. In exemplary embodiments three dimensional face recognition techniques may be useful to identify distinctive features on the surface of the face, for example, but not limited to a contour of eye socket, nose, and/or chin. In still further exemplary embodiments, it may be recognized that multiple facial recognition techniques may be used within a single implementation of the method 100, for example if it is determined that particular techniques are better suited for identification of particular facial features and/or conditions of the digital image.

FIG. 2B depicts an exemplary embodiment of a graphical user interface (GUI) 60 being presented on a graphical display 62 of a computer 64. The graphical user interface 60 presents the digital image with visual representations of facial recognition outputs and/or facial data as described in further detail herein.

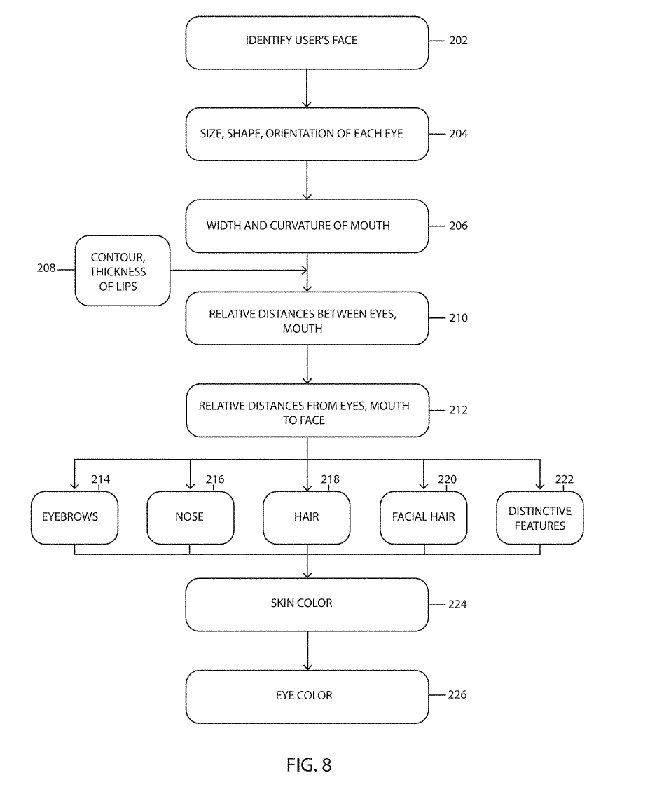

Next, at 108 the identified facial features are quantified to produce facial data. Once the facial features are identified at 106, the shape, size, angle and relative distance between the identified facial features to other facial features must be determined. Exemplarily, this quantification is characterized as a measurement of such characteristics of the facial features. Measurement techniques used to quantify the facial features include direct measurements, pixel characterization and selection, or back-side characterization and selection. In a further exemplary embodiment, a derivative analysis of adjacent pixel values is used to identify image boundaries of the various facial features which may be generally located by the facial recognition techniques. In an embodiment, an area of discontinuity or high rate of change between adjacent or close pixels may be used to identify a boundary between anatomical features. In an example, facial recognition techniques are used at 106 to identify the general area of the left eye in the digital image and then pixels in that area are selected (for example based upon derivative boundary analysis) to select the pixels representative of the facial feature of the left eye. Specific quantities and measurements as may be made in exemplary embodiments are described in further detail herein with respect to FIG. 2C and FIG. 8.

FIG. 2C depicts a digital image 70 with various examples of facial data. While not limiting on the scope of the facial data which may be used in embodiments as disclosed herein, the presented facial data is representative of facial data as may be used and persons of ordinary skill in the art will recognize other forms of facial data in view of these examples. In an exemplary embodiment, the face of the user is identified exemplarily as an ellipsoidal boundary. This may exemplarily take the form of an ellipsoid shape 72A as may be defined between the chin, top of the head, and sides of the face at the ears. In another exemplary embodiment, the ellipsoidal shape may be a circle 72B defining an area about some of the facial features.

Next, the image 70 presents various ways in which facial features may be quantified by representing boundaries of such features. 74A exemplarily defines an ellipsoid about the user's left eye, such ellipsoid can be mathematically defined and characterized as will be described in further detail herein. Such an ellipsoid may further include a rotation angle, for example an angulation of a major axis (not depicted) of the ellipsoid 74A. 74B represents a contour of an eyebrow as an arc. Similar to the ellipsoid representation of the left eye 74A, a mathematical expression of an arc or a spline may be used to represent a contour of an eyebrow. While not depicted in FIG. 2C, thickness measurements to the upper and lower bounds of the eyebrow from the arc 74B may further define the shape of the eyebrow. Alternatively, facial features can be quantified by identification of boundaries of such features for example by pixel characterization and selection, thus creating a contour line consisting of many discrete and empirically obtained data points. This is exemplarily represented by identification of the user's right eye 74C for example by definition of the edges of the eye lid. 74D exemplarily represents the boundaries of the user's right eyebrow. 74E represents the user's nose, while 74F represents the user's nostrils. The boundary of the user's mouth is identified by 74G. In an exemplary embodiment, the user's mouth 74G may be further delineated into the users top and bottom lips by identification of the boundary between the lips 74H.

Facial features can further be quantified as measurements. The measurements may exemplarily be distances, but may also be vectors which further specify an angular direction. Such measurements exemplarily relate various facial features to one another in the facial data. 76A is exemplarily a distance between the eyes. While a pupil-pupil distance is depicted, it will be recognized that other similar distances may be used, including between interior corners of the eyes, exterior corners of the eyes as well as center points (e.g. geometric centers) of the previously quantified eye shapes (e.g. 74A or 74C). 76B represents the distances between the centers of the eyes and the center of the mouth. Along with 76A this further forms a triangle which may be used in embodiments to properly locate the relative positions of the facial features in the personified emoji. Other examples of relative measurements may include the measurement 76C between the outside of the eyes and the corners of the mouth. 76D represents the measurement between the corners of the mouth to the tip of the nose. 76E represents distances from the centers of the eyes or the pupils the user's cheeks. The facial recognition techniques noted above, may exemplarily provide definitions of the users cheeks and/or tip of the nose even if such locations are not specifically represented in the personified emoji. Still further measurements may relate facial features to the boundary of the user's face. Exemplarily, 76F provides a measurement between the bottom of the user's mouth and the user's chin, exemplarily on ellipsoid 72A. 76G similarly represents distances between the corners of the user's mouth and the facial boundary 72A.

The measurements at 108 which quantify the facial features as facial data are aggregated at 110 to produce a facial data set which represents the facial features to be used in the personified emoji. Again, as mentioned above, in exemplary embodiments in which a user provides a selection of the desired facial features to be used in the personified emoji, the facial data set may be limited to the facial data which describes those selected features, rather than including all available facial data as may be quantified at 108. Alternatively, it will be recognized that in other embodiments, all of the facial data may be incorporated in to the facial data set at 110.

At 112 the method 100 optionally includes receiving a user selection or selections of an emoji template or templates as will be described in further detail herein. In the alternative to a user selected emoji template the method may operate based upon a default or standard emoji template which is modified as described herein to produce the personified emoji. As a nonlimiting embodiment, the default emoji template or the user selection of an emoji template may exemplarily come from an emoji as identified with character codes 1F600-1F64F as defined in the Unicode standard, Version 8.0 while this is used for exemplary purposes and not intended to be limiting on the scope or types of emoji templates.

At 116 the emoji template is obtained, whether that emoji template is a default template used by the system or if it is one which has been selected by the user. At 116 the facial data set is registered to the emoji template. By way of example, FIG. 2C depicts exemplary embodiments of facial data, including an ellipsoidal definition of the user's face, as well as relative measurements between the identified facial features in the digital image. These features, as well as the measurements of the facial features themselves must be registered to a circular shape which is characteristic of the emoji or another shape as may be defined in the emoji template. This is exemplarily shown in FIG. 2D which depicts an emoji 80 with transferred facial data. This registration between two differently shaped systems can be performed using various known geometric or mathematical transformation techniques. It will be recognized that “primed” reference numerals in FIG. 2D (e.g. 76A′; 76B′) exemplarily represent the transformed versions of the facial data as represented in FIG. 2C.

Through the registration of the facial data set to the emoji template, the individual measurements in the facial data are transformed to new values within the coordinate system of the emoji template. Next, the emoji facial features are modified at 118 according to the facial data of the facial data set. As can be seen by way of reference between FIGS. 2C and 2D, a general emoji facial feature, for example an eye or a mouth is exemplarily modified with the facial data of that facial feature as obtained from the image of the user. Thus, the emoji facial features are transformed to match at least one of the shape, size, location, or orientation of the identified and quantified facial features of the user.

In an optional embodiment, particularly an embodiment wherein the user provides a selection of an emoji template, the user may further provide selections of emoji facial feature templates at 120. For example, but not so limited, a user selection is obtained for an emoji eye template or emoji mouth template as well as other emoji facial feature templates as may be recognized based upon this disclosure. User selected emoji facial feature templates are obtained at 120 and it is those emoji facial feature templates obtained at 120 that are modified at 118 according to the facial data set to personalize the individual facial features used in the personified emoji.

Next, at 122 emoji facial features are located on the emoji template according to the facial data set. Thus, the emoji facial features are positioned based upon the registration between the facial data set and the emoji template to position the emoji facial features at the necessary relative distances between each of the other facial features as well as within the “face” of the emoji as circumscribed by the boundary 78 of the emoji template. As exemplarily depicted in FIGS. 2C and 2D, a triangular distance between the two eyes and the center of the mouth as represented in the facial data by 76A and 76B is transformed to a triangle in the emoji template represented by 76A′ and 76B′ by registration between the facial data set and the emoji template and the registered relationship used to properly orient and position the emoji facial features of the eyes and the mouth relative to one another within the personified emoji. FIGS. 2C and 2D depict further examples of measurement or other quantification which may be used to properly locate the emoji facial features within the emoji template.

It will be recognized that in an alternative embodiment, the modification of the emoji facial features as described above at 118 may be only optionally performed and in one embodiment of the personified emoji, emoji facial feature templates are used without further personalized modification or transformation, but are located within the emoji template according to the transformed facial data set as described at 122.

In a still further embodiment, at 126 a user selection or selections of manual emoji features may be received. As exemplarily used herein, manual emoji features may include, but are not limited to graphical representations of hats, turbans, glasses, jewelry or other accessories which may be presented from an exemplary library of manual emoji features and selections of such manual emoji features received from the user. FIG. 7 exemplarily depicts manual emoji features and this aspect is described in further detail with respect to FIG. 7. At 128 the manual emoji features are added to the personified emoji to further add individualization or customization to the automatedly produced personified emoji.

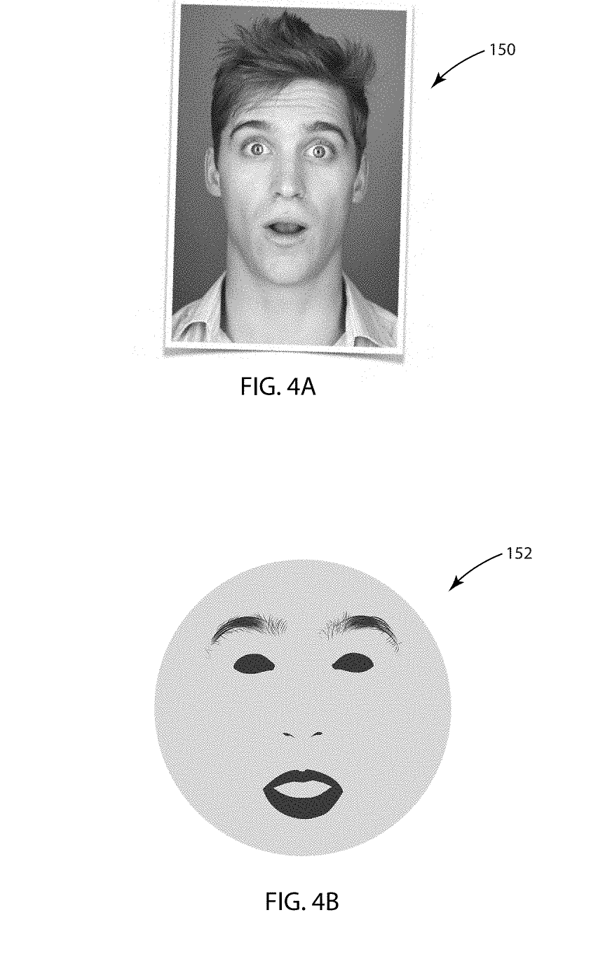

FIGS. 4A-6C depict various further examples of digital images and resulting personified emoji's. FIG. 4A depicts an exemplary embodiment of a digital image of a user 150. The digital image of FIG. 4A exemplarily differs from the digital image 50 of FIG. 2A in that the user is displaying a surprised expression in image 150 in FIG. 4A as opposed to neutral expression in image 50 in FIG. 2A. The surprised expression is exemplarily shown in the shapes of the raised eyebrows and the widely opened eyes. Further, the user's mouth is open. As explained in the present application, through facial recognition and quantification of these facial features, not only is the general expression expressed by the user (e.g. surprised) captured and embodied in the personified emoji 152 depicted in FIG. 4B, but rather the expression as specifically exhibited by the user is embodied in the personified emoji 152 of FIG. 4B. Thus, the shape, size, and form of the facial features, including but not limited to the eyebrows, eyes, and mouth are captured in the personified emoji 152. As depicted in FIG. 4B, the user's mouth may exemplarily be represented by two lips.

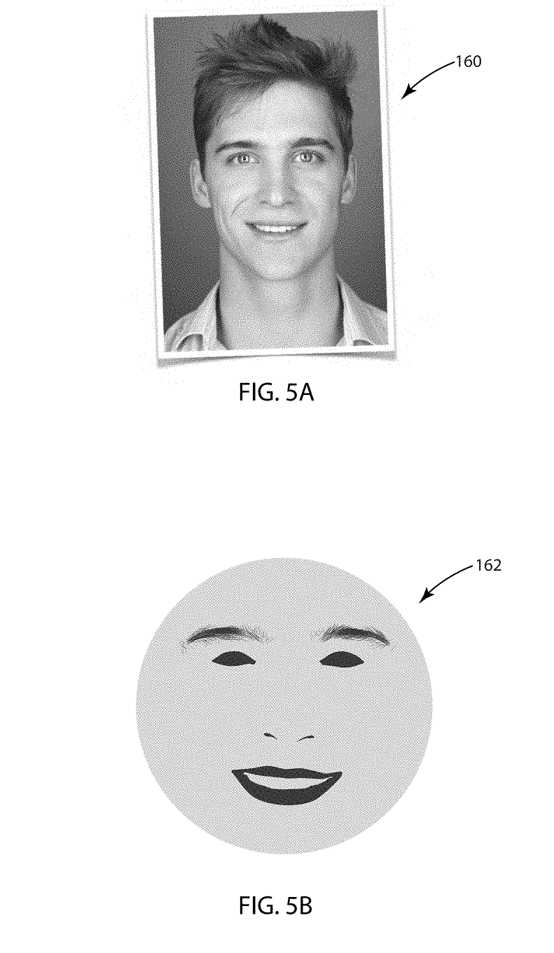

This is similarly depicted in FIGS. 5A and 5B in which the digital images 160 depicted in FIG. 5A has captured the user with a smirking expression, characterized by an asymmetric expression of the user's mouth. By quantifying the facial features, including quantifying the user's top and bottom lips as individual facial features, The facial feature template lips can be modified in thickness and dimension as well as relative positioning to the user's other facial features, including, but not limited to eyes, nose, and chin, resulting in the personified emoji 162 as presented in FIG. 5B.

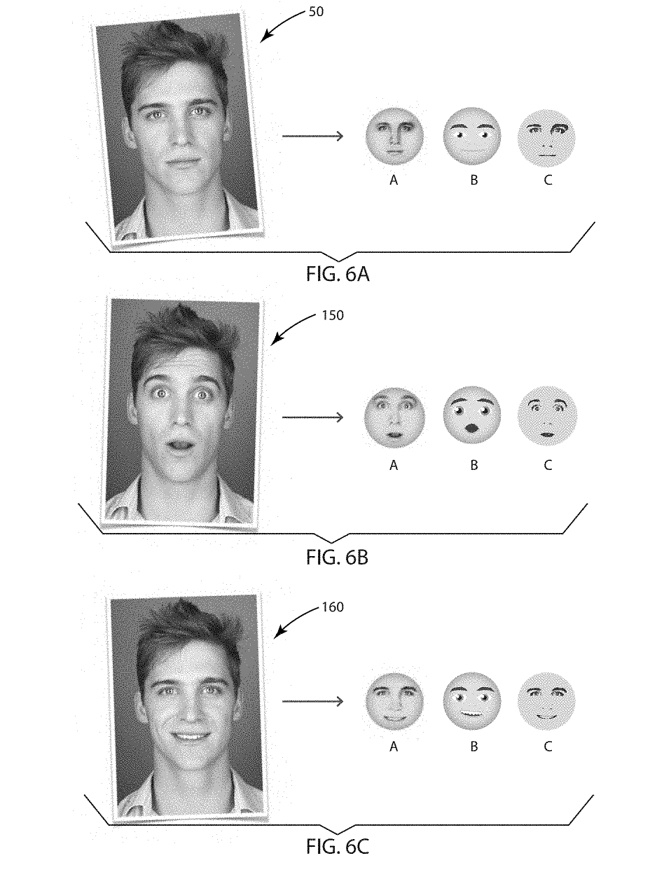

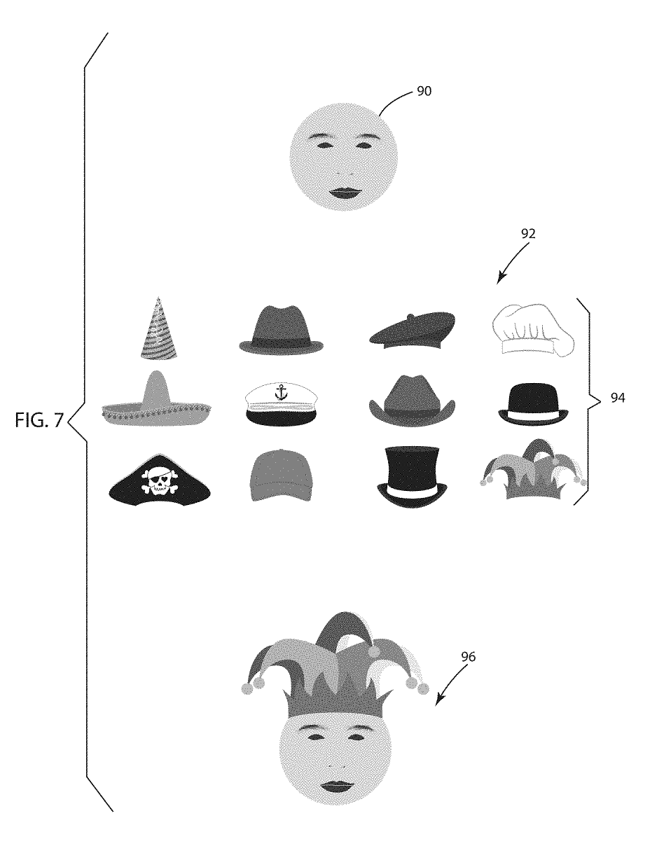

FIGS. 6A-6C respectfully present each of the exemplary digital images of the user described above in FIGS. 2A, 4A, and 5A. The examples provided in 6A-6C provide examples of two features of embodiments as disclosed herein. First, a user may create and save multiple personified emojis to represent a variety of expressions and/or context in electronic interpersonal communication. In one exemplary embodiment, the user may be prompted with various emoji templates to create an expression to personify that emoji template. For example, the user may be prompted to capture an image of a happy face, frown face, neutral, or surprised face. These personified emojis may be stored remotely at a server such that the personified emojis are available by online access to the server. Alternatively, the personified emojis may be stored locally to a mobile computing device or devices and available for use by the user in electronic interpersonal communication in a variety of electronic interpersonal communication platforms accessible through the mobile computing device.

FIGS. 6A-6C further exemplarily depict the differences that may be exhibited in personified emojis depending upon the emoji template used in creating the personified emoji. Personified emojis A, B and C each represent emojis as created from three different templates. It will be recognized that the “A” emojis use facial feature templates that incorporate more shading and provide the most detail of the facial features from the digital image. Exemplarily, the more detail that exists in the facial feature template, for example shapes, contours, 3-D data, the more that the facial feature template can be personified with corresponding facial feature data. The “B” emojis are the most cartoonish, and represent an example of an embodiment in which facial feature templates are used and exemplarily may not be modified with facial data. The facial data may exemplarily be used to select between facial feature templates rather than to modify a selected facial feature template. Such an embodiment, may further rely more upon relative distances between the facial features to locate the selected facial feature templates within the emoji template. Such an embodiment may use a smaller set of facial data. The “C” emojis use facial feature templates incorporating more lines to represent the facial features and present a level of personified detail between that of the “A” emojis and “B” emojis. It will also be recognized that in embodiments, one or more colors in the personified emoji may be modified to match color in the digital image such as lip color, skin color, eye color, or hair color between the digital image and the personified emoji. In a non-limiting example, the color information may be extracted from the digital image itself and translated to comparable colors within the personified emoji. In one non-limiting embodiment, the Fitzpatrick scale, for example, but not limited to, as implemented in the Unicode Version 8.0 standard may be used to modify personified emoji skin tone.

FIG. 7 depicts and additional exemplary embodiment of manually manipulated emoji features. FIG. 7 depicts how a personified emoji 90 created in the manner as described above can be further manipulated through the selection and use of manual emoji features. As explained above, the user may select one or more manual emoji features 92 from a library of manual emoji features 94 for further modification of the personified emoji 90. While the library of manual emoji features 94 in FIG. 7 exemplarily depicts hats, it will be recognized that this is merely exemplary of the types of manual emoji features which may be available in further embodiments. This may further include, but is not limited to glasses, jewelry, or other accessories. Once the user selects a manual emoji feature 92, the feature is added to the personalized emoji 90 to create a further personified emoji 96.

FIG. 8 is a flow chart that depicts an exemplary embodiment of a method 200 of quantifying facial features to produce facial data. The description herein of method 200 further exemplarily references the facial data as graphically depicted in FIG. 2C. For example, embodiments of the method 200 may be used to carry out the quantification of facial features to produce facial data at 108 with respect to the method 100 and FIG. 3.

The method 200 begins at 202 identifying the user's face 72A, 72B. It will be understood that this may be performed using facial recognition techniques and algorithms as described above. In at least one embodiment, the user's face in the digital image is identified as an ellipsoid encompassing the top of the person's head, the bottom of the user's chin and/or double chin, and the respective right and left sides of the cheeks. Once this boundary is identified it can be quantified, for example by measurement, and/or mathematical representation, and/or as a set of selected pixels in a grid.

Next, at 204 the size, shape, and orientation of each eye is determined. The orientation of each eye may exemplarily be an angle of the major axis through the generally ellipsoidal shape of the eye 74A. The size, shape, and orientation of each eye may be quantified by mathematical representation or as a series of boundary points within the defined face, exemplarily defined in a grid. In one exemplary embodiment, this quantification may include a contour trace 74C of the eyelids upon the eye, for example where the posterior palpebral border meets the bulbar conjunctiva. In another embodiment, the contour of the eye socket can be traced. Additionally, a distance between the eyes 76A can be measured. It will be recognized that measurements may be either direct measurements of relative distances between features or measurements may be made through indirect methods like pixel or voxel selection which are defined by their position on a grid. The distance between eyes 76A may exemplarily be a distance between the center of the eyes or alternatively a distance between similar points, including, but not limited to the respective interior and exterior corners of the eyes.

Next, a width and curvature of the mouth is determined. Again, this quantification can be made by mathematically representing the mouth as a whole within the identified face or may be quantified as a series of lines, or a selection of discrete data points on a grid, representing the dimensions of the mouth. Optionally, at 208 a contour and/or thickness of the lips may be quantified particularly in embodiments wherein at least a portion of the lips are separated, for example in the digital images of FIGS. 4A and 5A.

Next, relative dimensions between the eyes and mouth are measured. These relative distances may include a triangular distance between the center of each eye and a center of the mouth 76B. Additionally, a distance between the corner of each eye to the center of the mouth may be measured in a still further exemplary embodiment a distance between the corners of each eye to the corners of the mouth 76C is measured.

Next, at 212 relative distances from the eyes and mouth to the face are measured. They exemplarily include a distance between the eyes to the top of the forehead 76H, a distance of the corners and/or center of the mouth to the chin 76F, and distances from the eyes and the mouth to the cheeks 76E. In an embodiment, the cheeks may exemplarily be defined by the minor axis vertices of the ellipse representing the face, or may be its own referential point on the face identified by facial recognition algorithms and/or techniques as described above.

With some or all of the quantifications highlighted above, as well as others as will be recognized by a person of ordinary skill in the art in view of these examples, embodiments of the personified emoji may be created. As mentioned above, some embodiments of personified emoji may use only the relative distance measurements in combination with the identified user's face, may use only the size, shape and orientation or may use the quantification of the facial features as described above. Other embodiments will use both the quantification of the facial features as well as the measured distances. In still further embodiments, additional identification and characterization may be optionally used in embodiments. Exemplarily, some or all of these additional features may be incorporated into a standard or default emoji template, while in other embodiments the additional features may be optionally selected for inclusion in the personified emoji by the user.

At 214 the eyebrows may be quantified by defining an eyebrow contour 74B and further defining a variable thickness along the eyebrow contour. Additionally, the eyebrow contour may be defined as a line and/or curvature along the eyebrow. The eyebrows may further be quantified at 214 with a relative distance between the respective eye and the eyebrow along the contour of the eyebrow. Still further, a relative distance between the two eyebrows may be measured. Alternatively, the eyebrows may be represented by a series of (pixel size) data points on a grid, where a mathematical smoothing technique may be used to connect a line between the outer boundary points.

At 216 the user's nose is quantified for use in the personified emoji. The nose may be quantified at 216 by defining a triangular position from the center of both eyes to the tip and/or top of the nose. Similarly, a triangular position may be defined from the center and/or corners of the mouth to the tip and/or top of the nose 76D. A distance from the corners of the mouth and the corners of the each eye to a center line of the nose from the top of the nose to the tip of the nose may be measured. A width of the nose on both sides of the defined center line of the nose may be defined along an entire contour of the nose. Additionally, a size, shape, and angle of the nose tip may be identified. In an exemplary embodiment including 3D facial recognition, distance to the nose tip from the surface of the face may be defined.

It will be recognized that for each of the additional facial features, the aforementioned facial recognition techniques and algorithms are first used to identify such facial features so they can be quantified in the method 200 as described herein.

At 218 the additional feature of the user's hair is quantified for inclusion in the personified emoji. At 218 a contour line of the lower contour of the hair and/or the upper contour of the hair is quantified. Further, a distance of the lower contour of the hair may be measured from the center of the eyes and/or the corner of the eyes to the lower contour line. Further, a height of the hair may be measured as the distance between the lower contour line and the upper contour line of the hair.

At 220 the additional feature of facial hair may be quantified for inclusion in the personified emoji. The quantification of the facial hair at 220 may include quantifying a shape, width, and thickness of a mustache, for example by defining an upper and lower contour of the mustache. Similarly, a shape, width, and geometric shape of a beard may be quantified by defining at least one upper and lower contour of the beard. A distance from the lower lip to a lower contoured of the beard and a distance of the upper contour of the beard relative to the eye and the mouth may be measured. Additionally, a distance of a contour line of the beard and/or sideburn to the center of the center of the closer respective eye may be measured. Further a distance from the eyes along the entire contour of sideburns and/or upper beard may be measured. Additionally, a position of a lower end of the sideburns relative to the eyes and/or mouth may be measured. Finally, exemplarily a curvature of a contour of the sideburns may further be quantified.

Additionally, at 222 the method may further quantify any distinct contours, marks, moles, scars, or other distinguishing features on the surface of the user's face and the digital image which may be identified by the aforementioned facial recognition algorithms and/or techniques. Similar to the other additional features as discussed above, these distinctive features may further be quantified for example by identifying a contour and/or shape, size, or angle of such features as well as one or more relative distance measured between the identified feature and a referential point of the user's face, for example, with the eyes and/or mouth.

It will further be recognized based upon the present disclosure that the additional features highlighted herein are exemplary and not exclusive of additional features which may be identified and quantified for use in a personified emoji. Additionally, it will be recognized that rather than being identified and/or quantified for use in the personified emoji, the identified additional features may alternatively be selected by the user from a library of such facial features as manual emoji features added to the personified emoji as des above with respect to FIG. 7 in addition to those features which were identified and quantified as previously described.

At 224, a skin color may be quantified from the digital image. In one exemplary embodiment, the skin color may be identified from the values or average value of pixels of the digital image. In another example, the skin color may be characterized on the Fitzpatrick scale as described above or another relative scale which can be mapped to a color pallet range used in the personified emoji. In one exemplary embodiment, emoji's are often represented in a yellow face color and therefore in one embodiment, the skin color may be represented on a yellow toned scale of yellow between orange and yellow or by adjusting the tone of the yellow from dark to light. In still further embodiments, the skin color may be represented in a grey scale. Similarly, an eye color may be quantified at 226. The eye color, for example may be quantified directly from the digital image as a color value and either mapped directly to that color value in the personified emoji or may be translated to a closest represented color of a plurality of defined color options in the personified emoji. In a still further embodiment, the eye color may be represented on a grey scale and represented as a range from grey to black.

It will be recognized that the quantification of the facial features as carried out by the method 200 must be transformed to the personified emoji in order to convey this personalizing information within the bounds defined by the emoji. For example, this requires a transformation of the quantified facial features, for example the defined contours, sizes, shapes and relative distances onto the area defined by the emoji. In exemplary embodiments, both the ellipse used to quantify the boundary of the user's face as well as the circle used to represent the boundary of the emoji are quadratics. A quadratic function can similarly be used to transform the individual points of the quantified facial features between the elliptical face on the circular emoji. Once these two shapes and/or coordinate systems used to represent the user's face and the emoji template are registered to one another, then the transformation between the two systems can be applied between the facial data of facial features to the emoji feature templates and the emoji template as a whole.

It will be appreciated that the invention also extends to computer programs, particularly computer programs on or in a carrier, adapted for putting the invention into practice. The program may be in the form of source code, object code, a code, and intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at runtime. The main program contains at least one call to at least one of the subroutines. In addition, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage. Throughout the figures, similar or corresponding features are indicated by same reference numerals or labels.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of generating a personified emoji, the method comprising:
providing an emoji template that is configured to be modified;
obtaining a digital image of a user;
identifying a plurality of facial features in the digital image;
quantifying each of the plurality of facial features to generate facial data in a facial dataset, wherein the facial data is representative of the facial features identified in the digital image; and
modifying the emoji template with the facial data of the facial dataset to create the personified emoji, wherein the personified emoji is representative of the facial features identified in the digital image.

2. (canceled)

3. The method of claim 1, wherein the emoji template comprises a plurality of emoji features, each emoji feature corresponds to a facial feature of the plurality of facial features quantified in the facial dataset.

4. The method of claim 3, wherein each emoji feature is modified based upon the facial data for the corresponding facial feature in the facial dataset.

5. The method of claim 1, wherein the plurality of facial features includes a boundary of the user's face, wherein quantifying each of the plurality of facial features includes quantifying the boundary, further comprising registering the boundary quantified to an emoji template boundary in the emoji template to produce a registration between the facial dataset and the emoji template, wherein the emoji template comprises at least one emoji feature, and further comprising transforming the at least one emoji feature based upon the facial data for the facial feature in the facial dataset that corresponds to the emoji feature and the registration between the facial dataset and the emoji template.

6. The method of claim 5, wherein the at least one emoji feature is a plurality of emoji features, the facial data identifies a location of each of the plurality of facial features and the method further comprises locating each emoji feature on the emoji template according to the location of each of the plurality of facial features identified in the facial dataset.

7. The method of claim 6, further comprising registering the facial dataset to the emoji template, wherein emoji features are located based upon the facial data that identifies the location of each of the plurality of facial features and the registration between the facial dataset and the emoji template.

8. The method of claim 7, further comprising transforming the facial data based upon the registration between the facial dataset and the emoji template.

9. The method of claim 1, wherein the plurality of facial features comprises at least the user's eyes and the facial data comprises at least one of a size, shape, and angle of the user's eyes.

10. The method of claim 9, wherein the plurality of facial features further comprises the user's mouth and the facial data comprises at least one of a width and a curvature of the user's mouth and at least one relative distance between the eyes and the mouth.

11. The method of claim 21, wherein the plurality of facial features comprises at least one of the user's eyebrows, nose, hair, and facial hair.

12. The method of claim 1, further comprising receiving a user selection of the emoji template from a plurality of available emoji templates.

13. The method of claim 1, further comprising:
receiving a user selection of at least one manual emoji feature from a plurality of manual emoji features; and
modifying the personified emoji to further include the at least one manual emoji feature.

14. A system for producing a personified emoji, the system comprising:
a first non-transitory memory configured to store an emoji template;
a processor configured to receive a digital image of a user, configured to identify a plurality of facial features in the digital image, and to generate a facial dataset of facial data quantifying the facial features in the digital image, wherein the processor is further configured to modify the emoji template with the facial data of the facial dataset to produce the personified emoji; and
a second non-transitory memory configured to store the personified emoji.

15. The system of claim 14, wherein the processor is further configured to apply at least one facial recognition algorithm to the digital image to identify the plurality of facial features in the image.

16. The system of claim 14, wherein the second non-transitory memory is accessible by at least one interpersonal communication application for selective use of the personified emoji during interpersonal communication between the user and a recipient.

17. The system of claim 16, wherein the at least one interpersonal communication application is at least partially executed by the processor.

18. A system for personified emoji, the system comprising:
means for creating a personified emoji comprising a plurality of modified facial feature templates, the plurality of modified facial feature templates being produced by modifying facial feature templates with facial data representative of facial features identified in a digital image of a user, the modified facial feature templates being arranged in accordance with the facial data to create the personified emoji.

19. The system of claim 18, further comprising:
means for producing the facial data by quantifying facial features identified in the digital image of the user.

20. The system of claim 19, further comprising:
means for interpersonal electronic communication using the personified emoji.
